(19) United States
(12) Patent Application Publication
(10) Pub. No.: US 2024/0254370 A1
(43) Pub. Date: Aug. 1, 2024

(54) MATERIAL TAPE SYSTEM, MATERIAL TAPE SYSTEM ASSEMBLY, METHOD FOR PRODUCING A MATERIAL TAPE SYSTEM ASSEMBLY AND USE OF A MATERIAL TAPE SYSTEM

(71) Applicant: tesa SE, Norderstedt (DE)

(72) Inventors: Marten ROHDE, Bienenbuettel (DE); Ute ELLRINGMANN, Hamburg (DE); Katja MEYER, Hamburg (DE); Henning CHACATTE, Pinnerberg (DE); Björn ERDMANN, Hamburg (DE)

(73) Assignee: tesa SE, Norderstedt (DE)

(21) Appl. No.: 18/289,618

(22) PCT Filed: May 2, 2022
(86) PCT No.: PCT/EP2022/061713

§ 371 Date: Nov. 6, 2023

(30) Foreign Application Priority Data
May 5, 2021 (DE) 10 2021 204 549.9

(51) Int. Cl. C09J 7/40

(52) U.S. Cl. CPC C09J 7/403; C09J 2301/18; C09J 2301/208; C09J 2301/50

(57) ABSTRACT

A material tape system having a backing tape having a first end section and a second end section, a fixing adhesive tape detachably connected to the first end section of the backing tape on a first side of the backing tape, and a first connecting adhesive tape connected to the first end section of the backing tape on a second side of the backing tape that is opposite the first side of the backing tape, wherein the fixing adhesive tape and the first connecting adhesive tape are connected to the backing tape in such a way that, when the fixing adhesive tape is connected to the backing tape, a connecting adhesive surface of the first connecting adhesive tape is covered, and, when the fixing adhesive tape is detached from the backing tape, the connecting adhesive surface of the first connecting adhesive tape is exposed.

The present invention relates to a material tape system, a material tape system assembly, a method for producing a material tape system assembly and use of a material tape system.

Material tape systems are known from the prior art. The material tape systems have a backing tape, which has a first end section and a second end section and extends from the first end section to the second end section. It is possible, for example, for self-adhesive punched parts to be arranged on the backing tape, and for them to be successively detached from the backing tape and applied to surfaces of products in an automated process.

U.S. Pat. No. 3,127,303 A discloses a tape for use in splicing metal foil strips, comprising a foil layer, a coating of an adhesive which is tacky at room temperature and is arranged centrally on the foil layer and extends in the longitudinal direction of the tape, and spaced bands of a second adhesive on the foil layer on both sides of the central coating.

US 2008/0090053 A1 describes an article for applying colour to a surface, which article comprises a sheet of dry colourant having an edge, a front sheet surface and a rear sheet surface opposite the front sheet surface, and an adhesive on the rear sheet surface for connecting the sheet to the surface.

US 2019/0185722 A1 describes the concept of connecting packaging sections by separable splicing tapes in order to form an entire continuous automatic packaging film.

JP 2008 297 027 A also discloses connecting two webs to one another by means of a splice.

It is generally desirable to provide material tape systems which simplify handling, ensure time-efficient and resource-saving processes and increase process stability and process reliability.

It is therefore the object of the present invention to simplify handling, to ensure time-efficient and resource-saving processes and to increase process stability and process reliability.

According to a first aspect of the invention, the stated object is achieved by a material tape system having the features of Patent claim 1. The material tape system has a backing tape. The backing tape has a first end section and a second end section. The backing tape extends from the first end section to the second end section. The material tape system has a fixing adhesive tape. The fixing adhesive tape system has a fixing adhesive surface. By means of the fixing adhesive surface, the fixing adhesive tape is detachably connected to the first end section of the backing tape on a first side of the backing tape. The material tape system has a first connecting adhesive tape. The first connecting adhesive tape has a connecting section. By means of the connecting section, the first connecting adhesive tape is connected to the first end section of the backing tape on a second side of the backing tape, which is opposite to the first side of the backing tape. The fixing adhesive tape and the first connecting adhesive tape are connected to the backing tape in such a way that, when the fixing adhesive tape is connected to the backing tape, a connecting adhesive surface of the first connecting adhesive tape is covered, and, when the fixing adhesive tape is detached from the backing tape, the connecting adhesive surface of the first connecting adhesive tape is exposed.

The material tape system has the backing tape. The backing tape has the first end section and the second end section and extends from the first end section to the second end section. The first end section preferably has a first end face. The second end section preferably has a second end face. In particular, the backing tape extends from the first end section to the second end section in a backing tape direction of extent. The first end face is preferably arranged opposite to the second end face in the backing tape direction of extent in such a way that the first end face and the second end face point in opposite directions. The backing tape can have a release layer, which can be a release paper. Furthermore, the backing tape can have a backing layer connected to the release layer. The release layer preferably has a surface, facing away from the backing layer, with a section to which, in particular, pressure-sensitive adhesive surfaces can be connected and from which these pressure-sensitive adhesive surfaces can be detached particularly easily. A multiplicity of, in particular self-adhesive, punched parts can be arranged on this section of the surface of the release layer, for example. The backing layer ensures that the backing tape is of mechanically robust design in its main plane of extent, in particular with respect to tensile loads in the main plane of extent. The release layer can be arranged on the first side of the backing tape. Alternatively, the release layer can also be arranged on the second side of the backing tape. In a further alternative, the backing tape has only the release layer, and in particular no backing layer. The backing layer can be arranged on the second side of the backing tape. Alternatively, the backing layer can also be arranged on the first side of the backing tape. In the event that both the release layer and the backing layer are provided, it is possible, when the release layer is arranged on the first side of the backing tape and the backing layer is arranged on the second side of the backing tape, for the backing tape to provide the functionality of the release layer on the first side and the functionality of the backing layer on the second side. If the release layer is arranged on the second side of the backing tape and the backing layer is arranged on the first side of the backing tape, the backing tape can provide the functionality of the release layer on the second side and the functionality of the backing layer on the first side. The backing tape can be wound around a roll core of the material tape system.

The material tape system has the fixing adhesive tape. The fixing adhesive tape preferably has a backing layer and an adhesive layer. The backing layer ensures that the fixing adhesive tape is of mechanically robust design in its main plane of extent, in particular with respect to tensile loads in the main plane of extent. The adhesive layer is preferably connected to the backing layer. The adhesive layer is preferably pressure-sensitive. The pressure-sensitive adhesiveness of the adhesive layer ensures that the fixing adhesive tape can be connected to other elements, such as, for example, to the first end section of the backing tape or to a release tape or both to the first end section and to the release tape. The fixing adhesive tape has the fixing adhesive surface. By means of the fixing adhesive surface, the fixing adhesive tape is detachably connected to the first end section of the backing tape on the first side of the backing tape. The detachable connection between the fixing adhesive surface of the fixing adhesive tape and the first end section of the backing tape ensures that the fixing adhesive tape is connected to the backing tape and can be detached therefrom. The fixing adhesive tape is preferably detachably connected by means of the fixing adhesive surface on the first side of the backing tape to a section of the release layer of the backing tape on the first end section of the backing tape. In particular, the detachable connection between the fixing adhesive surface of the fixing adhesive tape and the section of the release layer of the backing tape ensures that the fixing adhesive tape and the backing tape can be detached from one another particularly easily, in particular when the connection between the fixing adhesive surface of the fixing adhesive tape and the section of the release layer of the backing tape is to be broken.

The connection between the fixing adhesive tape and the backing tape ensures that the backing tape can be connected with the aid of the fixing adhesive tape to, for example, the roll core of the material tape system or to a section of the backing tape, in particular on the first side of the backing tape, particularly when the backing tape is wound around the roll core. In the wound state, the backing tape can thus be connected to itself with the aid of the fixing adhesive tape, ensuring that the backing tape remains in the wound state. The detachment of the fixing adhesive tape from the backing tape ensures that the backing tape can be decoupled from the roll core of the material tape system or from the section of the backing tape, in particular on the first side of the backing tape, and in the process or subsequently the fixing adhesive tape can be detached from the backing tape. The detachable connection between the fixing adhesive tape and the backing tape ensures that the function of connecting the backing tape, for example to the roll core of the material tape system or to the section of the backing tape, in particular on the first side of the backing tape, can be fulfilled by the fixing adhesive tape and that the structural make up of the backing tape can be chosen independently of this function.

The adhesive layer of the fixing adhesive tape can form an adhesive surface which has a plurality of sections. A first section of the plurality of sections of the adhesive surface of the adhesive layer of the fixing adhesive tape can form the fixing adhesive surface by means of which the fixing adhesive tape is detachably connected to the first end section of the backing tape. A second section of the plurality of sections of the adhesive surface of the adhesive layer of the fixing adhesive tape preferably forms an adhesive surface by means of which the fixing adhesive tape can be detachably connected, for example, to the roll core of the material tape system or to a section of the backing tape, in particular on the first side of the backing tape. The second section can be exposed, in particular when the fixing adhesive tape is not detachably connected to the roll core of the material tape system or to a section of the backing tape, in particular on the first side of the backing tape. Furthermore, a third section of the plurality of sections of the adhesive surface of the adhesive layer of the fixing adhesive tape is preferably provided. The third section is preferably arranged between the first section and the second section. The third section is preferably covered by the release tape. The fixing adhesive tape can have a connecting section.

The material tape system has the first connecting adhesive tape. The first connecting adhesive tape preferably has a backing layer and an adhesive layer. The backing layer ensures that the first connecting adhesive tape is of mechanically robust design in its main plane of extent, in particular with respect to tensile loads in the main plane of extent. The adhesive layer can be connected to the backing layer. The adhesive layer is preferably pressure-sensitive. The pressure-sensitive adhesiveness of the adhesive layer ensures that the first connecting adhesive tape can be connected to other elements, such as, for example, to the first end section of the backing tape or to the release tape or both to the first end section and to the release tape.

The adhesive layer of the first connecting adhesive tape preferably forms an adhesive surface which has a plurality of sections. A first section of the plurality of sections of the adhesive surface of the adhesive layer of the first connecting adhesive tape preferably forms a connecting adhesive surface of the first connecting adhesive tape, which can be covered by the release tape. A second section of the plurality of sections of the adhesive surface of the adhesive layer of the first connecting adhesive tape, said second section being adjacent to the first section, preferably forms an adhesive surface by means of which the first connecting adhesive tape is connected to the first end section of the backing tape.

The first connecting adhesive tape has the connecting section. By means of the connecting section, the first connecting adhesive tape is connected to the first end section of the backing tape on the second side of the backing tape, which is opposite to the first side of the backing tape The connection between the connecting section of the first connecting adhesive tape and the first end section of the backing tape ensures that, when the first connecting adhesive tape is connected to a further element, the backing tape is connected to this further element via the first connecting adhesive tape. The connection between the connecting section of the first connecting adhesive tape and the first end section of the backing tape can be ensured by an adhesive surface formed by the second section of the plurality of sections of the adhesive surface of the adhesive layer of the first connecting adhesive tape, by means of which the first connecting adhesive tape is connected to the first end section of the backing tape.

The fixing adhesive tape and the first connecting adhesive tape are connected to the backing tape in such a way that, when the fixing adhesive tape is connected to the backing tape, the connecting adhesive surface of the first connecting adhesive tape is covered. In this case, the connecting adhesive surface can be covered by the release tape. Thus, when the fixing adhesive tape is connected to the backing tape, the connecting adhesive surface of the first connecting adhesive tape is covered, ensuring that when the material tape system is used, the first connecting adhesive tape does not adhere by means of the connecting adhesive surface to objects to which it is not intended to adhere. Furthermore, when the connecting adhesive surface of the first connecting adhesive tape is covered, the connecting adhesive surface is protected from contamination while using the material tape system.

The fixing adhesive tape and the first connecting adhesive tape are connected to the backing tape in such a way that, when the fixing adhesive tape is detached from the backing tape, the connecting adhesive surface of the first connecting adhesive tape is exposed. Owing to the fact that, when the fixing adhesive tape is detached from the backing tape, the connecting adhesive surface of the first connecting adhesive tape is exposed, it is possible, by detaching the fixing adhesive tape from the backing tape, to selectively expose the connecting adhesive surface in order to connect it selectively to other elements, such as, for example, to a connecting adhesive surface of a second connecting adhesive tape of another material tape system or to the second end section of the backing tape of the other material tape system on the second side of the backing tape of the other material tape system or both to the connecting adhesive surface of the second connecting adhesive tape of the other material tape system and to the second end section of the backing tape of the other material tape system on the second side of the backing tape of the other material tape system.

In particular, the material tape system ensures a plurality of functions by virtue of its construction and, in particular, by virtue of the fixing adhesive tape and the interaction of the fixing adhesive tape with the other elements of the material tape system. First, the backing tape can be detachably attached to further elements, such as, for example, to a roll core of the material tape system, with the aid of the fixing adhesive tape. Furthermore, the structural make up of the backing tape can be selected independently of the function of detachable attachment of the backing tape to further elements. This enables the backing tape to be of particularly flexible design in terms of its intended use. For example, the backing tape can be designed to be particularly light and at the same time mechanically robust, in particular tear-resistant. Moreover, the construction of the material tape system and, in particular, the fixing adhesive tape ensures the selective covering and exposure of the connecting adhesive surface of the first connecting adhesive tape, ensuring, on the one hand, that it is protected from contamination and, on the other hand, that it can be exposed when required. The material tape system thus ensures that the backing tape can be of mechanically robust design and that the use of the material tape system is particularly user-friendly. The user-friendliness is ensured, in particular, by the fact that the connecting adhesive surface can be exposed in a simple manner by detaching the fixing adhesive tape from the backing tape.

As already indicated, the material tape system, which can also be referred to as the first material tape system, can be connected to a further material tape system, which can also be referred to as the second material tape system. If at least two material tape systems are connected to one another, this assembly can also be referred to as a material tape system assembly. In particular, it is envisaged that, in the first material tape system, the fixing adhesive tape is first detached from the backing tape, with the result that the connecting adhesive surface of the first connecting adhesive tape is exposed, and then the first material tape system is connected to the second material tape system. Thus, in the material tape system assembly, at least the first material tape system has the fixing adhesive tape detached from the backing tape. This circumstance can also be designated in such a way that the first material tape system in the material tape system assembly has no fixing adhesive tape. In particular, the first material tape system and the second material tape system are connected to one another in such a way that the connecting adhesive surface of the first connecting adhesive tape of the first material tape system is connected to the second end section of the backing tape of the second material tape system on a second side of the backing tape of the second material tape system. Connecting a first material tape system to a second material tape system can also be referred to as splicing. In particular, the backing tape of the first material tape system can be connected to the backing tape of the second material tape system by connecting the first material tape system to the second material tape system.

As a result of the construction of the material tape system according to the invention, in particular as a result of the special connection of the fixing adhesive tape and of the first connecting adhesive tape to the backing tape, the material tape system can be used in a material tape system assembly in a simple and time-saving manner since all that is necessary to connect two material tape systems is to detach the fixing adhesive tape from the backing tape, and a simple connection possibility is thereby provided by the connecting adhesive surface of the first connecting adhesive tape. Particularly when a multiplicity of material tape systems is connected to one another in a material tape system assembly in such a way that each pair of adjacent material tape systems has a first material tape system and a second material tape system, wherein the connecting adhesive surface of the first connecting adhesive tape of the first material tape system is connected to the second end section of the backing tape of the second material tape system on a second side of the backing tape of the second material tape system, the simple connection of the material tape systems is particularly advantageous and the time saving potential is particularly pronounced. By virtue of the construction of the material tape system according to the invention, it is possible in particular to connect a plurality of backing tapes to one another particularly quickly. In particular, the material tape system according to the invention ensures simple handling since no additional material has to be provided for connecting a plurality of backing tapes since the connecting adhesive surface of the first connecting adhesive tape is already provided by the material tape system. This is advantageous particularly in comparison with material tape systems known from the prior art, which have a backing tape but no connecting adhesive tape according to the invention since it is often necessary in this case to provide additional adhesive tapes to connect backing tapes.

The following advantages have been found, particularly when using a material tape system in an automated robot applicator.

By virtue of the simple handling and time-saving connection of a plurality of material tape systems, the material changing times, in particular the time period between the use of a first material tape system and a second material tape system, have been significantly reduced since, when the backing tape of a first material tape system is unwound from the roll core of the first material tape system, the roll core of the first material tape system can be removed from the robot applicator, the roll core of the second material tape system can be inserted into the robot applicator, and the backing tape of the first material tape system can be connected to the backing tape of the second material tape system simply and quickly. It is thereby possible to accelerate and improve the efficiency of automated processes with automated robot applicators.

Furthermore, it has proven possible, with the aid of the material tape system according to the invention, to significantly increase process stability, particularly when used in an automated robot applicator since the material tape system according to the invention, particularly in a material tape system assembly, can be guided through a guide of the automated robot applicator in a manner which is consistent and predictable over time. In particular, the high process stability is ensured by the fact that the backing tapes of two adjacent material tape systems of a material tape system assembly can be positioned in a particularly precise manner with respect to one another. The particularly precise positioning of the backing tapes is ensured, in particular, by the first connecting adhesive tape, which is already attached to one end of a backing and has only to be connected to the second backing tape. It has been found that an operator of the automated robot applicator positions two backing tapes of two material tape systems according to the invention much more precisely with respect to one another than is the case with material tape systems known from the prior art.

Furthermore, it has been found that, with the aid of the material tape system according to the invention, process reliability, particularly when used in an automated robot applicator, could be significantly increased since the connection of two backing tapes of two material tape systems according to the invention is mechanically much more robust than is the case in the prior art. In particular, it has been found that two backing tapes of two material tape systems according to the invention are much more difficult to detach from one another than is the case in the prior art.

Furthermore, it has been found that when a plurality of material tape systems according to the invention with a roll core are used in a robot applicator, if the backing tape of a first material tape system of the plurality of material tape systems has already been unwound from the roll core but is still connected thereto, the robot applicator can be stopped, the backing tape of the first material tape system can be connected to the backing tape of the second material tape system of the plurality of material tape systems, and the robot applicator can then be started again, thus ensuring that the backing tape of the second material tape system is unwound from the roll core. By virtue of this procedure, it is possible, when using a multiplicity of material tape systems, to produce a continuous backing tape which has a multiplicity of backing tapes. With each connection of two backing tapes to produce the continuous backing tape, it is possible to use the total length of each backing tape, and thus, for example, also the total number of punched parts arranged on the backing tape, thereby making it possible to save material in comparison with the method known from the prior art, in particular through the use of all of the punched parts. Thus, particularly resource-saving methods are made possible with the aid of the material tape system according to the invention. Moreover, with each connection of two backing tapes to produce the continuous backing tape, it is possible to dispense with rethreading of the material tape system into the robot applicator, and therefore particularly time-efficient methods are made possible.

In summary, it can therefore be stated that the material tape system according to the invention simplifies handling, ensures time-efficient and resource-saving processes and increases process stability and process reliability.

In one embodiment, the material tape system has a release tape having a first side and a second side, wherein, when the fixing adhesive tape is connected to the backing tape, the release tape is arranged between the fixing adhesive tape and the first connecting adhesive tape in such a way that the fixing adhesive surface faces the first side of the release tape and the connecting adhesive surface faces the second side of the release tape. The release tape preferably has a release layer. The release layer can be a release paper. Furthermore, the release tape can have a backing layer. The backing layer is preferably connected to the release layer. The release layer preferably has a surface facing away from the backing layer, to which surface it is possible, in particular, to connect pressure-sensitive adhesive surfaces, such as, for example, the connecting adhesive surface of the first connecting adhesive tape, and from which these pressure-sensitive adhesive surfaces can be detached particularly easily. In particular, the backing layer ensures that the release tape is of mechanically robust design in its main plane of extent, in particular with respect to tensile loads in the main plane of extent. Furthermore, the release tape preferably has a first side and a second side. The backing layer is preferably arranged on the first side of the backing tape. The release layer is preferably arranged on the second side of the release tape. In particular, the release tape is arranged between the fixing adhesive tape and the first connecting adhesive tape. The release tape preferably rests against the first end face of the first end section and thereby covers the latter, thus ensuring that the first end face is protected from mechanical effects, such as, for example, elastic or plastic deformations of the first end face, such as, for example, cracks in the first end face. As already described, the fixing adhesive tape is connected to the backing tape. In this case, the release tape is preferably arranged between the fixing adhesive tape and the first connecting adhesive tape in such a way that the first section, which forms the fixing adhesive surface of the fixing adhesive tape, the second section and the third section of the plurality of sections of the adhesive surface of the adhesive layer of the fixing adhesive tape face the first side of the release tape. Here, the third section of the plurality of sections of the adhesive surface of the adhesive layer of the fixing adhesive tape is preferably covered by the release tape. In particular, the release tape is arranged between the fixing adhesive tape and the first connecting adhesive tape in such a way that the connecting adhesive surface of the first connecting adhesive tape faces the second side of the release tape. The connecting adhesive surface of the first connecting adhesive tape is preferably covered by the release tape.

In one embodiment, the release tape is connected on its first side to the fixing adhesive tape and is detachably connected on its second side to the connecting adhesive surface of the first connecting adhesive tape in such a way that, when the fixing adhesive tape is detached from the backing tape, the release tape is detached from the connecting adhesive surface. Owing to the fact that the release tape is connected on its first side to the fixing adhesive tape and is detachably connected on its second side to the connecting adhesive surface of the first connecting adhesive tape in such a way that, when the fixing adhesive tape is detached from the backing tape, the release tape is detached from the connecting adhesive surface, the connecting adhesive surface can be exposed by removing the fixing adhesive tape and thereby removing the release tape. Exposure of the connecting adhesive surface can thus also be ensured in the case where a release tape is provided.

In one embodiment, the connecting adhesive surface of the first connecting adhesive tape is covered by the release tape. The covering of the connecting adhesive surface of the first connecting adhesive tape by the release tape ensures that the connecting adhesive surface is protected with the aid of the release tape, in particular from contamination. The release tape is preferably designed, arranged and connected to the fixing adhesive tape in such a way that, when the fixing adhesive tape is connected to the backing tape, the connecting adhesive surface of the first connecting adhesive tape is directly covered by the release tape, i.e. the latter rests against the connecting adhesive surface and completely covers it.

In one embodiment, a first adhesive force acting from the fixing adhesive surface to the backing tape is less than a second adhesive force acting from a connecting section of the fixing adhesive tape to the release tape. The second adhesive force preferably acts from the third section of the plurality of sections of the adhesive surface of the adhesive layer of the fixing adhesive tape to the release tape. The first and second adhesive forces are preferably to be understood to mean a force threshold which must be overcome in order to detach the corresponding elements from one another under a load perpendicular to the connecting surfaces of the individual elements. The first adhesive force is preferably a force threshold which must be overcome in order to detach the backing tape and the fixing adhesive tape from one another, and the second adhesive force is a force threshold which must be overcome in order to detach the fixing adhesive tape and the release tape from one another.

In one embodiment, the second adhesive force acting from the connecting section of the fixing adhesive tape to the release tape is greater than a third adhesive force acting from the connecting adhesive surface of the first connecting adhesive tape to the release tape. The third adhesive force is preferably to be understood to mean a force threshold which must be overcome in order to detach the corresponding elements from one another under a load perpendicular to the connecting surfaces of the individual elements. The third adhesive force is preferably a force threshold which must be overcome in order to detach the first connecting adhesive tape and the release tape from one another.

In one embodiment, the third adhesive force acting from the connecting adhesive surface of the first connecting adhesive tape to the release tape is less than a fourth adhesive force acting from the connecting section of the first connecting adhesive tape to the first end section of the backing tape. The fourth adhesive force is preferably to be understood to mean a force threshold which must be overcome in order to detach the corresponding elements from one another under a load perpendicular to the connecting surfaces of the individual elements. The fourth adhesive force is preferably a force threshold which must be overcome in order to detach the first connecting adhesive tape and the backing tape from one another.

The material tape system is preferably designed in such a way that, when the material tape system is subjected to a tensile load perpendicular to the connecting surfaces of the individual elements, in that a tensile force acts on the fixing adhesive tape and an oppositely acting tensile force acts on the first connecting adhesive tape, both the backing tape and the fixing adhesive tape are detached from one another and the connecting adhesive tape and the release tape are detached from one another, wherein both the fixing adhesive tape and the release tape and also the backing tape and the first connecting adhesive tape remain connected to one another. This can be achieved, in particular, by matching the pressure-sensitive adhesiveness of the different pressure-sensitive adhesive surfaces to one another.

In particular, the pressure-sensitive adhesiveness of the different pressure-sensitive adhesive surfaces is matched to one another as follows. A first strength threshold value of the connection between the fixing adhesive surface and the backing tape is preferably lower than a second strength threshold value of the connection between the connecting section of the fixing adhesive tape and the release tape. In particular, the second strength threshold relates to the connection between the third section of the plurality of sections of the adhesive surface of the adhesive layer of the fixing adhesive tape and the release tape. Furthermore, the second strength threshold value of the connection between the connecting section of the fixing adhesive tape and the release tape is preferably higher than a third strength threshold value of the connection between the connecting adhesive surface of the first connecting adhesive tape and the release tape. Furthermore, the third strength threshold value of the connection between the connecting adhesive surface of the first connecting adhesive tape and the release tape is preferably lower than a fourth strength threshold value of the connection between the connecting section of the first connecting adhesive tape and the first end section of the backing tape. The first, second, third and fourth strength threshold values are preferably each to be understood to mean a strength threshold value which must be overcome in order to detach the corresponding elements from one another under a load perpendicular to the connecting surfaces of the individual elements and perpendicular to the first connecting adhesive tape direction of extent. The first strength threshold value is preferably a strength threshold value which must be overcome in order to detach the backing tape and the fixing adhesive tape from one another, the second strength threshold value is preferably a strength threshold value which must be overcome in order to detach the fixing adhesive tape and the release tape from one another, the third strength threshold value is preferably a strength threshold value which must be overcome in order to detach the first connecting adhesive tape and the release tape from one another, and the fourth strength threshold value is a strength threshold value which must be overcome in order to detach the first connecting adhesive tape and the backing tape from one another.

The features, technical effects and/or advantages described in connection with the first, second, third and fourth adhesive forces and in connection with the first, second, third and fourth strength threshold values preferably also apply, at least in an analogous manner, to a first, second, third and fourth peeling force, which describes the force threshold which must be overcome in order to pull one element off another element. For example, it is envisaged that when the outermost end of the fixing adhesive tape is initially pulled upwards perpendicularly to the connecting surfaces of the individual elements and perpendicularly to the first connecting adhesive tape direction of extent and then upwards and counter to the first connecting adhesive tape direction of extent, both the backing tape and the fixing adhesive tape as well as the connecting adhesive tape and the release tape are detached from one another owing to the ratios of the first, second, third and fourth peeling forces with respect to one another, wherein both the fixing adhesive tape and the release tape as well as the backing tape and the first connecting adhesive tape remain connected to one another.

In one embodiment, when the fixing adhesive tape is connected to the backing tape, the connecting adhesive surface of the first connecting adhesive tape is arranged on the first side of the backing tape. The first connecting adhesive tape is preferably folded around the first end section of the backing tape. The first connecting adhesive tape can be arranged in a U shape. The first connecting adhesive tape preferably encloses the first end section of the backing tape in such a way that the first end face is covered by the first connecting adhesive tape, thus ensuring that the first end face is protected by the first connecting adhesive tape. The third section of the plurality of sections of the adhesive surface of the adhesive layer of the fixing adhesive tape is preferably provided. In particular, the third section forms a pressure-sensitive adhesive surface, by means of which the fixing adhesive tape is connected to a surface of a section of the backing layer of the first connecting adhesive tape on the side of the backing layer of the first connecting adhesive tape. The surface of the section of the backing layer of the first connecting adhesive tape may itself not be of pressure-sensitive adhesive design. However, in comparison with the surface of the section of the release layer, the surface of the section of the backing layer of the first connecting adhesive tape is preferably designed in such a way that the material bond between the fixing adhesive tape and the first connecting adhesive tape is mechanically more robust than the material bond between the fixing adhesive tape and the backing tape. The material tape system preferably has no release tape when the fixing adhesive tape is connected to the backing tape and the connecting adhesive surface of the first connecting adhesive tape is arranged on the first side of the backing tape. It is thereby possible to provide a material tape system which makes particularly sparing use of resources.

In one embodiment, the first connecting adhesive tape extends in a first connecting adhesive tape direction of extent away from the first end section of the backing tape, wherein an extent of the connecting section of the first connecting adhesive tape in the connecting adhesive tape direction of extent corresponds to between 20% and 40%, preferably between 30 and 35%, of an extent of the first connecting adhesive tape in the connecting adhesive tape direction of extent. By virtue of the fact that the extent of the connecting section of the first connecting adhesive tape in the connecting adhesive tape direction of extent can correspond to between 20% and 40%, preferably between 30 and 35%, of an extent of the first connecting adhesive tape in the connecting adhesive tape direction of extent, it is possible to ensure both a mechanically robust overlapping connection between the backing tape and the first connecting adhesive tape and a sufficiently large connecting adhesive surface of the first connecting adhesive tape for mechanically robust connections. This effect is observable over a total range of 20% to 40% and is particularly pronounced in a range of 30% to 35%. It has surprisingly been found that, if the extent of the connecting section of the first connecting adhesive tape in the first connecting adhesive tape direction of extent corresponds to 33% of the extent of the first connecting adhesive tape in the first connecting adhesive tape direction of extent, the overlapping connection between the backing tape and the first connecting adhesive tape and the mechanically robust connections with the aid of the connecting adhesive surface of the first connecting adhesive tape can be matched to one another in a particularly advantageous manner.

In one embodiment, the material tape system has a roll core with a circumferential outer surface, wherein the fixing adhesive tape has a connecting section, by means of which the fixing adhesive tape is connected, in particular detachably, to the outer surface. By virtue of the fact that the fixing adhesive tape has the connecting section, by means of which the fixing adhesive tape is connected, in particular detachably, to the outer surface, the backing tape can be connected to the roll core by its first end section in such a way that, in the rolled-up state, the first end section of the backing tape is arranged radially inwardly in comparison with the second end section of the backing tape.

In one embodiment, the material tape system has a second connecting adhesive tape having a connecting section, by means of which the second connecting adhesive tape is connected to the second end section of the backing tape on the first side of the backing tape, and having a connecting adhesive surface. The second connecting adhesive tape preferably has a connecting section and a connecting adhesive surface. By means of the connecting section, the second connecting adhesive tape is connected to the second end section of the backing tape, preferably on the first side of the backing tape. The connection between the connecting section of the second connecting adhesive tape and the second end section of the backing tape ensures that, when the second connecting adhesive tape is connected to a further element, the backing tape is connected to this further element via the second connecting adhesive tape. The connection between the connecting section of the second connecting adhesive tape and the second end section of the backing tape can ensure, for example, that the backing tape can be connected with the aid of the second connecting adhesive tape to, for example, a roll core of the material tape system or to a section of the backing tape, in particular on the first side of the backing tape, particularly when the backing tape is wound around the roll core. The second connecting adhesive tape preferably has a backing layer and an adhesive layer. The backing layer ensures that the second connecting adhesive tape is of mechanically robust design in its main plane of extent, in particular with respect to tensile loads in the main plane of extent. The adhesive layer is connected, in particular, to the backing layer. The adhesive layer is preferably pressure-sensitive and thus ensures that the second connecting adhesive tape can be connected to other elements. The adhesive layer of the second connecting adhesive tape preferably forms an adhesive surface which has a plurality of sections. A first section of the plurality of sections of the adhesive surface of the adhesive layer of the second connecting adhesive tape preferably forms the connecting adhesive surface of the second connecting adhesive tape. A second section of the plurality of sections of the adhesive surface of the adhesive layer of the second connecting adhesive tape, said second section being adjacent to the first section, preferably forms an adhesive surface by means of which the second connecting adhesive tape is connected to the second end section of the backing tape. Preferably, the second connecting adhesive tape extends in a second connecting adhesive tape direction of extent. The second connecting adhesive tape preferably extends in the second connecting adhesive tape direction of extent away from the second end section of the backing tape. It has proven particularly advantageous that an extent of the connecting section of the second connecting adhesive tape in the second connecting adhesive tape direction of extent can correspond to between 20% and 40%, preferably between 30 and 35%, of an extent of the second connecting adhesive tape in the second connecting adhesive tape direction of extent since this ensures both a mechanically robust overlapping connection between the backing tape and the second connecting adhesive tape and a sufficiently large connecting adhesive surface of the second connecting adhesive tape for mechanically robust connections. This effect is observable over a total range of 20% to 40% and is particularly pronounced in a range of 30% to 35%. As a particular preference, the extent of the connecting section of the second connecting adhesive tape in the second connecting adhesive tape direction of extent corresponds to 33% of the extent of the second connecting adhesive tape in the second connecting adhesive tape direction of extent. It has surprisingly been found that at 33%, the overlapping connection between the backing tape and the second connecting adhesive tape and mechanically robust connections with the aid of the connecting adhesive surface of the second connecting adhesive tape can be matched to one another in a particularly advantageous manner.

In one embodiment, the material tape system has a roll core with a circumferential outer surface, wherein the second connecting adhesive tape is connected, in particular detachably, to the outer surface by means of the connecting adhesive surface. By virtue of the fact that the second connecting adhesive tape is connected, in particular detachably, to the outer surface by means of the connecting adhesive surface, the backing tape can be connected to the roll core by its second end section in such a way that, in the rolled-up state, the second end section of the backing tape is arranged radially inwardly in comparison with the first end section of the backing tape.

In one embodiment, a multiplicity of punched parts is arranged on the first side of the backing tape and/or a multiplicity of punched parts is arranged on the second side of the backing tape. The material tape system can therefore be used to provide punched parts. In particular, it has been found that the advantageous effects associated with this invention apply particularly to the case where a multiplicity of punched parts is arranged on the first side of the backing tape and/or a multiplicity of punched parts is arranged on the second side of the backing tape. In particular, it is possible for a multiplicity of punched parts to be arranged exclusively on the first side of the backing tape. Alternatively, it is possible for a multiplicity of punched parts to be arranged exclusively on the second side of the backing tape. It is furthermore possible both for a multiplicity of punched parts to be arranged on the first side of the backing tape and for a multiplicity of punched parts to be arranged on the second side of the backing tape. In this way, different arrangements of punched parts can be provided on the backing tape. By means of different arrangements of punched parts on the backing tape, it is possible to arrange the punched parts of the corresponding application in an optimum manner. It is thereby possible to provide material tape systems that can be used in a flexible manner.

According to a second aspect of the invention, the object stated at the outset is achieved by a material tape system assembly having the features of Patent claim 14. The material tape system assembly has a first material tape system according to the first aspect of the invention. The material tape system assembly has a second material tape system according to the first aspect of the invention. The connecting adhesive surface of the first connecting adhesive tape of the first material tape system is connected to the second end section of the backing tape of the second material tape system on a second side of the backing tape of the second material tape system. It is thereby possible to provide a mechanically robust connection between the first material tape system and the second material tape system.

In a first embodiment, the connecting adhesive surface of the second connecting adhesive tape of the second material tape system is connected to the first end section of the backing tape of the first material tape system on the first side of the backing tape of the first material tape system. It is thereby possible to further increase the mechanical robustness of the connection between the first material tape system and the second material tape system.

In one embodiment, the backing tape of the first material tape system and the backing tape of the second material tape system are arranged in such a way that a first tangential surface running perpendicularly to the connecting adhesive surface of the first connecting adhesive tape of the first material tape system runs along a first edge region of the first end section of the backing tape of the first material tape system and along a first edge region of the second end section of the backing tape of the second material tape system, and a second tangential surface running parallel to the first tangential surface runs along a second edge region of the first end section of the backing tape of the first material tape system and along a second edge region of the second end section of the backing tape of the second material tape system. By virtue of this arrangement, the backing tape of the first material tape system and the backing tape of the second material tape system are aligned, which is advantageous particularly when the material tape system assembly is used in an automated robot applicator since, in particular, process stability and process reliability are thereby increased.

In one embodiment, a first end face of the first end section of the backing tape of the first material tape system and a second end face of the second end section of the backing tape of the second material tape system rest against one another. By virtue of the fact that the first end face of the first end section of the backing tape of the first material tape system and the second end face of the second end section of the backing tape of the second material tape system rest against one another, the backing tape of the first material tape system and the backing tape of the second material tape system can be positioned particularly precisely with respect to one another. Precise positioning of the backing tapes with respect to one another is advantageous particularly when the material tape system assembly is used in an automated robot applicator since the guidance of the material tape system assembly by the robot applicator is simplified and, in particular, the likelihood of the material tape system assembly being caught in the robot applicator is significantly reduced.

The features, technical effects and/or advantages described in connection with the material tape system according to the first aspect of the invention also apply at least in an analogous manner to the material tape system assembly according to the second aspect of the invention, and therefore corresponding repetition is dispensed with at this point.

According to a third aspect of the invention, the object stated at the outset is achieved by a method having the features of Patent claim 18. The method is provided for producing a material tape system assembly according to the second aspect of the invention. The method has the following steps: providing the first material tape system; providing the second material tape system; detaching the fixing adhesive tape from the backing tape of the first material tape system; and connecting the connecting adhesive surface of the first connecting adhesive tape of the first material tape system to the second end section of the backing tape of the second material tape system on the second side of the backing tape of the second material tape system.

In one embodiment, the method has the following step: connecting the connecting adhesive surface of the second connecting adhesive tape of the second material tape system to the first end section of the backing tape of the first material tape system on the first side of the backing tape of the first material tape system.

Even if the method steps are described in a specific sequence, the present invention is not limited to this sequence. On the contrary, the individual method steps can be carried out in any appropriate sequence, in particular also, at least section-wise, in parallel with one another with respect to time.

The features, technical effects and/or advantages described in connection with the material tape system according to the first aspect of the invention and in connection with the material tape system assembly according to the second aspect of the invention also apply at least in an analogous manner to the method according to the third aspect of the invention, and therefore corresponding repetition is dispensed with at this point.

According to a fourth aspect of the invention, the object stated at the outset is achieved by a use having the features of Patent claim 20. The use relates to a use of a material tape system according to the first aspect of the invention in an automated robot applicator. The features, technical effects and/or advantages described in connection with the material tape system according to the first aspect of the invention, in connection with the material tape system assembly according to the second aspect of the invention and in connection with the method according to the third aspect of the invention also apply at least in an analogous manner to the use according to the fourth aspect of the invention, and therefore corresponding repetition is dispensed with at this point.

Further features, advantages and possible applications of the present invention will be found in the following description of the exemplary embodiments and the figures. All of the features described and/or illustrated in the figures form the subject matter of the invention individually and in any combination, irrespective of their combination in the individual claims or dependency references thereof. In the figures, the same reference signs furthermore denote the same or similar objects.

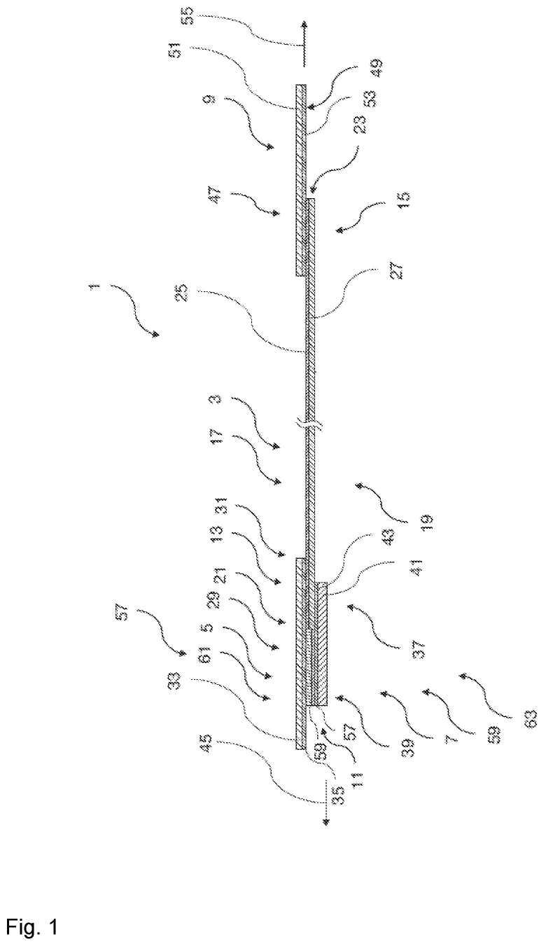

FIG. 1 shows a schematic view of a first embodiment of a material tape system according to the invention,

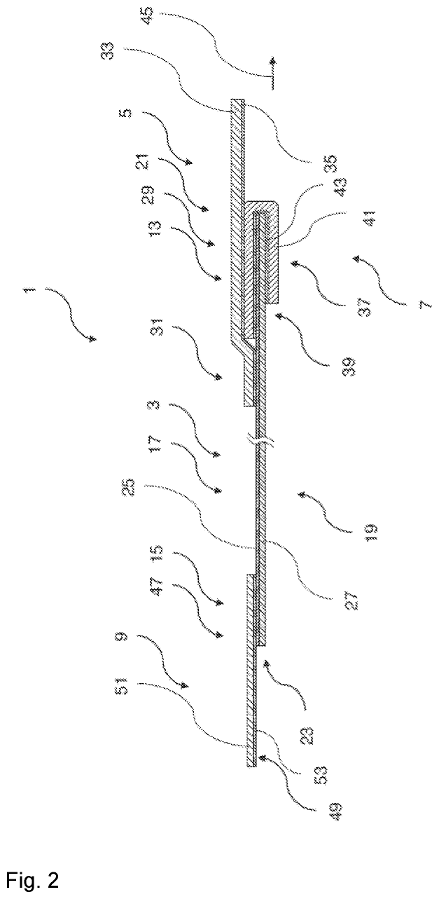

FIG. 2 shows a schematic view of a second embodiment of the material tape system according to the invention,

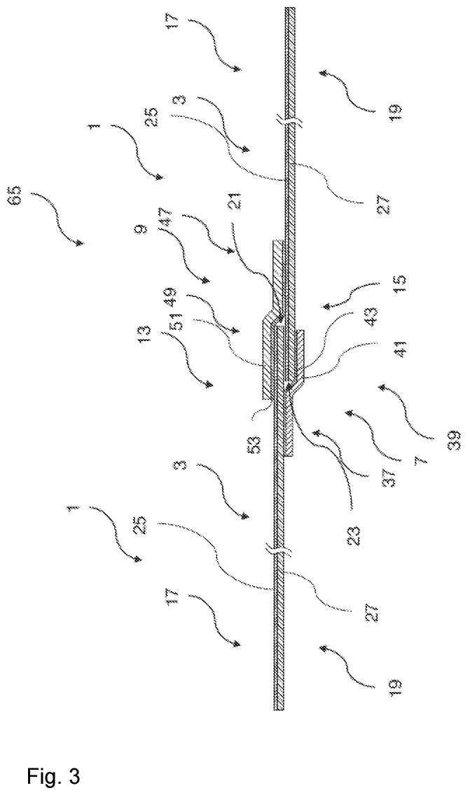

FIG. 3 shows a schematic view of one embodiment of a material tape system assembly according to the invention, and

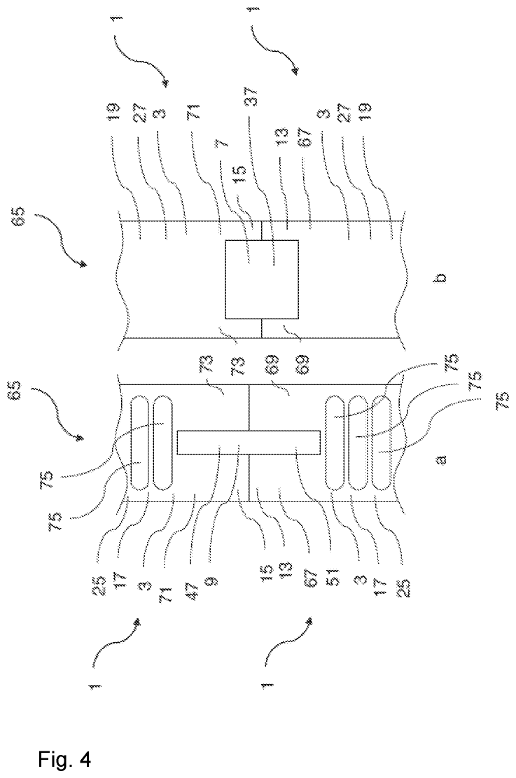

FIG. 4 shows two schematic views of the embodiment of the material tape system assembly according to the invention in FIG. 3 in a top view (FIG. 4a) and in a view from below (FIG. 4b).

FIG. 1 shows a schematic view of a first embodiment of a material tape system 1 according to the invention. The material tape system 1 has a backing tape 3, a fixing adhesive tape 5, a first connecting adhesive tape 7, a second connecting adhesive tape 9 and a release tape 11.

The backing tape 3 has a first end section 13 and a second end section 15. The backing tape 3 extends from the first end section 13 to the second end section 15. The backing tape 3 has a first side 17 and a second side 19 opposite to the first side 17. The first end section 13 has a first end face 21, which, in the first embodiment of the material tape system 1 according to the invention, is covered by the release tape 11 in the state shown in FIG. 1. The second end section 15 has a second end face 23, which, in the first embodiment of the material tape system 1 according to the invention, is exposed in the state shown in FIG. 1. The first end face 21 is arranged opposite to the second end face 23 in a backing tape direction of extent in such a way that the first end face 21 and the second end face 23 point in opposite directions. The backing tape 3 has a release layer 25, which, in the first embodiment of the material tape system 1 according to the invention, is a release paper, and a backing layer 27 connected to the release layer 25. The release layer 25 has a surface, facing away from the backing layer 27, with a section to which, in particular, pressure-sensitive adhesive surfaces can be connected and from which these pressure-sensitive adhesive surfaces can be detached particularly easily. The backing layer 27 ensures that the backing tape 3 is of mechanically robust design in its main plane of extent, in particular with respect to tensile loads in the main plane of extent. The release layer 25 is arranged on the first side 17 of the backing tape 3. The backing layer 27 is arranged on the second side 19 of the backing tape 3. By virtue of the fact that the release layer 25 is arranged on the first side 17 of the backing tape 3 and the backing layer 27 is arranged on the second side 19 of the backing tape 3, the backing tape 3 can provide the functionality of the release layer 27 on the first side 17 and the functionality of the backing layer 27 on the second side 19. The backing tape can be wound around a roll core (not illustrated in FIG. 1) of the material tape system 1.

The fixing adhesive tape 5 has a connecting section 29 and a fixing adhesive surface 31. The fixing adhesive tape 5 is detachably connected to the first end section 13 of the backing tape 3, more specifically to a section of the release layer 25 of the backing tape 3, by means of the fixing adhesive surface 31 on the first side 17 of the backing tape 3. The detachable connection between the fixing adhesive surface 31 of the fixing adhesive tape 5 and the first end section 13 of the backing tape 3 ensures that the fixing adhesive tape 5 is connected to the backing tape 3 and can be detached therefrom. In particular, the detachable connection between the fixing adhesive surface 31 of the fixing adhesive tape 5 and the section of the release layer 25 of the backing tape 3 ensures that the fixing adhesive tape 5 and the backing tape 3 can be detached from one another particularly easily, in particular when the connection between the fixing adhesive surface 31 of the fixing adhesive tape 5 and the section of the release layer 25 of the backing tape 3 is to be broken. The connection between the fixing adhesive tape 5 and the backing tape 3 ensures that the backing tape 3 can be connected with the aid of the fixing adhesive tape 5 to, for example, a roll core of the material tape system 1 or to a section of the backing tape 3, in particular on the first side 17 of the backing tape 3, particularly when the backing tape 3 is wound around the roll core. The detachment of the fixing adhesive tape 5 from the backing tape 3 ensures that the backing tape 3 can be decoupled from the roll core of the material tape system 1 or from the section of the backing tape 3, in particular on the first side 17 of the backing tape 3, in that the fixing adhesive tape 5 can be detached from the backing tape 3 during this process or subsequently. The detachable connection between the fixing adhesive tape 5 and the backing tape 3 ensures that the function of connecting the backing tape 3, for example on the roll core of the material tape system 1 or on the section of the backing tape 3, in particular on the first side 17 of the backing tape 3, can be fulfilled by the fixing adhesive tape 5 and that the structural make up of the backing tape 3 can be chosen independently of this function.

The fixing adhesive tape 5 has a backing layer 33 and an adhesive layer 35. The backing layer 33 ensures that the fixing adhesive tape 5 is of mechanically robust design in its main plane of extent, in particular with respect to tensile loads in the main plane of extent. The adhesive layer 35 is connected to the backing layer 33. The adhesive layer 35 exhibits pressure-sensitive adhesion and thus ensures that the fixing adhesive tape 5 can be connected to other elements, such as, for example, the first end section 13 of the backing tape 3 or to the release tape 11 or both to the first end section 13 and to the release tape 11. The adhesive layer 35 of the fixing adhesive tape 5 forms an adhesive surface which has a plurality of sections. A first section of the plurality of sections of the adhesive surface of the adhesive layer 35 of the fixing adhesive tape 5 forms the fixing adhesive surface 31, by means of which the fixing adhesive tape 5 is detachably connected to the first end section 13 of the backing tape 3. A second section of the plurality of sections of the adhesive surface of the adhesive layer 35 of the fixing adhesive tape 5 forms an adhesive surface by means of which the fixing adhesive tape 5 can be detachably connected, for example, to the roll core of the material tape system 1 or to a section of the backing tape 3, in particular on the first side 17 of the backing tape 3. The second section is exposed in FIG. 1. Furthermore, a third section of the plurality of sections of the adhesive surface of the adhesive layer 35 of the fixing adhesive tape 5 is provided. The third section is arranged between the first section and the second section and is covered by the release tape 11 in FIG. 1.

The first connecting adhesive tape 7 has a connecting section 37 and a connecting adhesive surface 39. By means of the connecting section 37, the first connecting adhesive tape 7 is connected to the first end section 13 of the backing tape 3 on the second side 19 of the backing tape 3, which is opposite to the first side 17 of the backing tape 3. The connection between the connecting section 37 of the first connecting adhesive tape 7 and the first end section 13 of the backing tape 3 ensures that, when the first connecting adhesive tape 7 is connected to a further element, the backing tape 3 is connected to this further element via the first connecting adhesive tape 7. In the first embodiment of the material tape system 1 according to the invention illustrated in FIG. 1, the connecting adhesive surface 39 is covered by the release tape 11.

The first connecting adhesive tape 7 has a backing layer 41 and an adhesive layer 43. The backing layer 41 ensures that the first connecting adhesive tape 7 is of mechanically robust design in its main plane of extent, in particular with respect to tensile loads in the main plane of extent. The adhesive layer 43 is connected to the backing layer 41. The adhesive layer 43 exhibits pressure-sensitive adhesion and thus ensures that the first connecting adhesive tape 7 can be connected to other elements, such as, for example, the first end section 13 of the backing tape 3 or to the release tape 11 or both to the first end section 13 and to the release tape 11. The adhesive layer 43 of the first connecting adhesive tape 7 forms an adhesive surface which has a plurality of sections. A first section of the plurality of sections of the adhesive surface of the adhesive layer 43 of the first connecting adhesive tape 7 forms the connecting adhesive surface 39 of the first connecting adhesive tape 7, said surface being covered by the release tape 11 in FIG. 1. A second section of the plurality of sections of the adhesive surface of the adhesive layer 43 of the first connecting adhesive tape 7, said second section being adjacent to the first section, forms an adhesive surface by means of which the first connecting adhesive tape 7 is connected to the first end section 13 of the backing tape 3.

The first connecting adhesive tape 7 extends in a first connecting adhesive tape direction of extent 45, the vector representation of which is arranged in the main plane of extent of the first connecting adhesive tape 7. The first connecting adhesive tape 7 extends in the first connecting adhesive tape direction of extent 45 away from the first end section 13 of the backing tape 3. It has proven particularly advantageous that an extent of the connecting section 37 of the first connecting adhesive tape 7 in the first connecting adhesive tape direction of extent 45 can correspond to between 20% and 40%, preferably between 30 and 35%, of an extent of the first connecting adhesive tape 7 in the first connecting adhesive tape direction of extent 45 since it is thereby possible to ensure both a mechanically robust overlapping connection between the backing tape 3 and the first connecting adhesive tape 7 and a sufficiently large connecting adhesive surface 39 of the first connecting adhesive tape 7 for mechanically robust connections. This effect is observable over a total range of 20% to 40% and is particularly pronounced in a range of 30% to 35%. In the first embodiment of the material tape system 1 according to the invention shown in FIG. 1, the extent of the connecting section 37 of the first connecting adhesive tape 7 in the first connecting adhesive tape direction of extent 45 corresponds to 33% of the extent of the first connecting adhesive tape 7 in the first connecting adhesive tape direction of extent 45. It has surprisingly been found that at 33%, the overlapping connection between the backing tape 3 and the first connecting adhesive tape 7 and mechanically robust connections with the aid of the connecting adhesive surface 39 of the first connecting adhesive tape 7 can be matched to one another in a particularly advantageous manner.

The second connecting adhesive tape 9 has a connecting section 47 and a connecting adhesive surface 49. By means of the connecting section 47, the second connecting adhesive tape 9 is connected to the second end section 15 of the backing tape 3 on the first side 17 of the backing tape 3. The connection between the connecting section 47 of the second connecting adhesive tape 9 and the second end section 15 of the backing tape 3 ensures that, when the second connecting adhesive tape 9 is connected to a further element, the backing tape 3 is connected to this further element via the second connecting adhesive tape 9. The connection between the connecting section 47 of the second connecting adhesive tape 9 and the second end section 15 of the backing tape 3 can ensure, for example, that the backing tape 3 can be connected with the aid of the second connecting adhesive tape 9 to, for example, a roll core of the material tape system 1 or to a section of the backing tape 3, in particular on the first side 17 of the backing tape 3, particularly when the backing tape 3 is wound around the roll core. In the first embodiment of the material tape system according to the invention illustrated in FIG. 1, the connecting adhesive surface 49 is exposed.

The second connecting adhesive tape 9 has a backing layer 51 and an adhesive layer 53. The backing layer 51 ensures that the second connecting adhesive tape 9 is of mechanically robust design in its main plane of extent, in particular with respect to tensile loads in the main plane of extent. The adhesive layer 53 is connected to the backing layer 51. The adhesive layer 53 is pressure-sensitive and thus ensures that the second connecting adhesive tape 9 can be connected to other elements. The adhesive layer 53 of the second connecting adhesive tape 9 forms an adhesive surface which has a plurality of sections. A first section of the plurality of sections of the adhesive surface of the adhesive layer 53 of the second connecting adhesive tape 9 forms the connecting adhesive surface 49 of the second connecting adhesive tape 9. A second section of the plurality of sections of the adhesive surface of the adhesive layer 53 of the second connecting adhesive tape 9, said second section being adjacent to the first section, forms an adhesive surface by means of which the second connecting adhesive tape 9 is connected to the second end section 15 of the backing tape 3.

The second connecting adhesive tape 9 extends in a second connecting adhesive tape direction of extent 55, the vector representation of which is arranged in the main plane of extent of the second connecting adhesive tape 9. The second connecting adhesive tape 9 extends in the second connecting adhesive tape direction of extent 55 away from the second end section 15 of the backing tape 3. It has proven particularly advantageous that an extent of the connecting section 47 of the second connecting adhesive tape 9 in the second connecting adhesive tape direction of extent 55 can correspond to between 20% and 40%, preferably between 30 and 35%, of an extent of the second connecting adhesive tape 9 in the second connecting adhesive tape direction of extent 55 since this ensures both a mechanically robust overlapping connection between the backing tape 3 and the second connecting adhesive tape 9 and a sufficiently large connecting adhesive surface 49 of the second connecting adhesive tape 9 for mechanically robust connections. This effect is observable over a total range of 20% to 40% and is particularly pronounced in a range of 30% to 35%. In the first embodiment of the material tape system 1 according to the invention shown in FIG. 1, the extent of the connecting section 47 of the second connecting adhesive tape 9 in the second connecting adhesive tape direction of extent 55 corresponds to 33% of the extent of the second connecting adhesive tape 9 in the second connecting adhesive tape direction of extent 55. It has surprisingly been found that at 33%, the overlapping connection between the backing tape 3 and the second connecting adhesive tape 9 and mechanically robust connections with the aid of the connecting adhesive surface 49 of the second connecting adhesive tape 9 can be matched to one another in a particularly advantageous manner.

As already described, the backing tape 3 can be connected with the aid of the second connecting adhesive tape 5 to the roll core of the material tape system 1 or to a section of the backing tape 3, in particular on the first side 17 of the backing tape 3, particularly when the backing tape 3 is wound around the roll core 3. In particular, when the backing tape 3 is wound around the roll core and the backing tape 3 is connected to the roll core of the material tape system 1 with the aid of the fixing adhesive tape 5, the backing tape 3 can be connected to the section of the backing tape 3, in particular on the first side 17 of the backing tape 3, with the aid of the second connecting adhesive tape 9. Alternatively, in particular when the backing tape 3 is wound around the roll core and the backing tape 3 is connected to the roll core of the material tape system 1 with the aid of the second connecting adhesive tape 9, the backing tape 3 can be connected to the section of the backing tape 3, in particular on the first side 17 of the backing tape 3, with the aid of the fixing adhesive tape 5. These two alternatives ensure that the backing tape 3 can be connected to the roll core and simultaneously to itself, in particular by means of a section on the first side 17 of the backing tape 3, thus ensuring that the backing tape 3 remains in the state in which it is wound around the roll core. If the backing tape 3 is in the state in which it is wound around the roll core, the material tape system 1 can be stored in a particularly space-saving manner. In order to use the material tape system 1, it is possible, when the backing tape 3 is connected to the section of the backing tape 3, in particular on the first side 17 of the backing tape 3, with the aid of the second connecting adhesive tape 9, for the second connecting adhesive tape 9 to be detached from the section of the backing tape 3 and then for the backing tape 3 to be unwound from the roll core. If the backing tape 3 is connected to the section of the backing tape 3, in particular on the first side 17 of the backing tape 3, with the aid of the fixing adhesive tape 5, the fixing adhesive tape 5 can be detached from the section of the backing tape 3 in order to use the material tape system 1, and then the backing tape 3 can be unwound from the roll core. In connection with these two alternatives, the release layer 25, in particular, has proven to be advantageous since this can have a section to which, in particular, the pressure-sensitive adhesive surfaces, such as, for example, the adhesive surface of the fixing adhesive tape 5, by means of which the fixing adhesive tape 5 can be detachably connected to the section of the backing tape 3 on the first side 17 of the backing tape 3, i.e. the second section of the plurality of sections of the adhesive surface of the adhesive layer 35 of the fixing adhesive tape 5, or the connecting adhesive surface 49, can be connected and from which these pressure-sensitive adhesive surfaces can be detached particularly easily.

The release tape 11 has a release layer 57, which, in the first embodiment of the material tape system 1 according to the invention, is a release paper, and a backing layer 59 connected to the release layer 57. The release layer 57 preferably has a surface facing away from the backing layer 59, to which surface it is possible, in particular, to connect pressure-sensitive adhesive surfaces, such as, for example, the connecting adhesive surface 39 of the first connecting adhesive tape 7, and from which these pressure-sensitive adhesive surfaces can be detached particularly easily. The backing layer 59 ensures that the release tape 11 is of mechanically robust design in its main plane of extent, in particular with respect to tensile loads in the main plane of extent. Furthermore, the release tape 11 has a first side 61 and a second side 63. The backing layer 59 is arranged on the first side 61 of the release tape 11. The backing layer 57 is arranged on the second side 63 of the release tape 11. The release tape 11 is arranged between the fixing adhesive tape 5 and the first connecting adhesive tape 7. The release tape 11 rests against the first end face 21 of the first end section 13 and thereby covers the latter, thus ensuring that the first end face 21 is protected from mechanical effects, such as, for example, elastic or plastic deformations of the first end face 21, such as, for example, cracks in the first end face 21. As already described, in the configuration shown in FIG. 1, the fixing adhesive tape 5 is connected to the backing tape 3. In this case, the release tape 11 is arranged between the fixing adhesive tape 5 and the first connecting adhesive tape 7 in such a way that the first section, which forms the fixing adhesive surface 31 of the fixing adhesive tape 5, the second section and the third section of the plurality of sections of the adhesive surface of the adhesive layer 35 of the fixing adhesive tape 5 face the first side 61 of the release tape 11. Here, the third section of the plurality of sections of the adhesive surface of the adhesive layer 35 of the fixing adhesive tape 5 is covered by the release tape 11. Furthermore, the release tape 11 is arranged between the fixing adhesive tape 5 and the first connecting adhesive tape 7 in such a way that the connecting adhesive surface 39 of the first connecting adhesive tape 7 faces the second side 63 of the release tape 11. The connecting adhesive surface 39 of the first connecting adhesive tape 7 is preferably covered by the release tape 11.

In the first embodiment of the material tape system 1 according to the invention shown in FIG. 1, it is advantageous, in particular, that the fixing adhesive tape 5 and the first connecting adhesive tape 7 are each connected to the backing tape 3 in a certain way. To be specific, the fixing adhesive tape 5 and the first connecting adhesive tape 7 are connected to the backing tape 3 in such a way that, when the fixing adhesive tape 5 is connected to the backing tape 3, the connecting adhesive surface 39 of the first connecting adhesive tape 7 is covered. The fixing adhesive tape 5 and the first connecting adhesive tape 7 are furthermore connected to the backing tape 3 in such a way that, when the fixing adhesive tape 5 is detached from the backing tape 3, the connecting adhesive surface 39 of the first connecting adhesive tape 7 is exposed.

Thus, when the fixing adhesive tape 5 is connected to the backing tape 3, the connecting adhesive surface 39 of the first connecting adhesive tape 7 is covered, ensuring that when the material tape system 1 is used, the first connecting adhesive tape 7 does not adhere with the connecting adhesive surface 39 to objects to which it is not intended to adhere. Furthermore, when the connecting adhesive surface 39 of the first connecting adhesive tape 7 is covered, the connecting adhesive surface 39 is protected from contamination when using the material tape system 1.

Furthermore, when the fixing adhesive tape 5 is detached from the backing tape 3, the connecting adhesive surface 39 of the first connecting adhesive tape 7 is exposed, thus making it possible, by detaching the fixing adhesive tape 5 from the backing tape 3, to selectively expose the connecting adhesive surface 39 in order to connect it selectively to other elements, such as, for example, to the connecting adhesive surface 49 of the second connecting adhesive tape 9 of another material tape system 1 or to the second end section 15 of the backing tape 3 of the other material tape system 1 on the second side 19 of the backing tape 3 of the other material tape system 1 or both to the connecting adhesive surface 49 of the second connecting adhesive tape 9 of the other material tape system 1 and to the second end section 15 of the backing tape 3 of the other material tape system 1 on the second side 19 of the backing tape 3 of the other material tape system 1.

In summary, the material tape system 1 ensures a plurality of functions by virtue of its construction and, in particular, by virtue of the fixing adhesive tape 5 and the interaction of the fixing adhesive tape 5 with the other elements of the material tape system 1. First, the backing tape 3 can be detachably attached to further elements, such as, for example, to a roll core of the material tape system 1, with the aid of the fixing adhesive tape 5. Furthermore, the structural make up of the backing tape 3 can be selected independently of the function of detachable attachment of the backing tape 3 to further elements. This enables the backing tape 3 to be of particularly flexible design in terms of its intended use. For example, the backing tape 3 can be designed to be particularly light and at the same time mechanically robust, in particular tear-resistant. Moreover, the construction of the material tape system 1 and, in particular, the fixing adhesive tape 5 ensures the selective covering and exposure of the connecting adhesive surface 39 of the first connecting adhesive tape 7, ensuring, on the one hand, that it is protected from contamination and, on the other hand, that it can be exposed when required. The material tape system 1 thus ensures that the backing tape 3 can be of mechanically robust design and that the use of the material tape system 1 is particularly user-friendly. The user-friendliness is ensured, in particular, by the fact that the connecting adhesive surface 39 can be exposed in a simple manner by detaching the fixing adhesive tape 5 from the backing tape 3.

As already described, the first embodiment of the material tape system 1 according to the invention has the release tape 11. The release tape 11 is designed, arranged and connected to the fixing adhesive tape 5 in such a way that, when the fixing adhesive tape 5 is connected to the backing tape 3, the connecting adhesive surface 39 of the first connecting adhesive tape 7 is directly covered by the release tape 11, i.e. the latter rests against the connecting adhesive surface 39 and completely covers it. Furthermore, the release tape 11 is designed, arranged and connected to the fixing adhesive tape 5 in such a way that, when the fixing adhesive tape 5 is detached from the backing tape 3, the connecting adhesive surface 39 of the first connecting adhesive tape 7 is exposed, i.e. the release tape 11 does not rest against the connecting adhesive surface 39 and also does not cover the latter. The release tape 11 is connected on its first side 61 to the fixing adhesive tape 5 and is detachably connected on its second side 63 to the connecting adhesive surface 39 of the first connecting adhesive tape 7 in such a way that, when the fixing adhesive tape 5 is detached from the backing tape 3, the release tape 11 is released from the connecting adhesive surface 39. Thus, the connecting adhesive surface 39 can be exposed by removing the fixing adhesive tape 5 and thereby removing the release tape 11.

The first embodiment of the material tape system 1 according to the invention is advantageous, in particular, by virtue of the arrangement of the backing tape 3, of the fixing adhesive tape 5, of the connecting adhesive tape 7 and of the release tape 11 relative to one another and by virtue of their interactions with one another, in particular by virtue of the interaction of different pressure-sensitive adhesive surfaces whose pressure-sensitive adhesive properties are matched to one another.

The fixing adhesive tape 5 has the pressure-sensitive adhesive layer 35, which has the adhesive surface with the plurality of sections. The first section of the plurality of sections of the adhesive surface of the adhesive layer 35 forms the pressure-sensitive fixing adhesive surface 5, by means of which the fixing adhesive tape 5 is detachably connected to the first end section 13 of the backing tape 3 on the first side 17 of the backing tape 3. In this case, the pressure-sensitive fixing adhesive surface 31 is connected to a section of the release layer 25 of the backing tape 3, wherein the surface of this section of the release layer 25 does not have pressure-sensitive adhesive properties, and therefore the pressure-sensitive fixing adhesive surface 31 can be detached particularly easily from this surface of the section of the release layer 25.

Between the first section and the second section (which is exposed in FIG. 1) of the plurality of sections of the adhesive surface of the adhesive layer 35 of the fixing adhesive tape 5, the third section of the plurality of sections of the adhesive surface of the adhesive layer 35 of the fixing adhesive tape 5 is provided. The third section forms a pressure-sensitive adhesive surface, by means of which the fixing adhesive tape 5 is connected to a surface of the backing layer 59 of the release tape 11 on the first side 61 of the release tape 11. The surface of the backing layer 59 of the release tape 11 itself is not of pressure-sensitive adhesive design. However, in comparison with the surface of the section of the release layer 25, the surface of the backing layer 59 of the release tape 11 is designed in such a way that the material bond between the fixing adhesive tape 5 and the release tape 11 is mechanically more robust than the material bond between the fixing adhesive tape 5 and the backing tape 3.

The first connecting adhesive tape 7 has the pressure-sensitive adhesive layer 43, which has the adhesive surface with the plurality of sections. The first section of the plurality of sections of the adhesive surface of the adhesive layer 43 forms the pressure-sensitive connecting adhesive surface 39, which is covered by the release tape 11 in FIG. 1. In this case, the pressure-sensitive connecting adhesive surface 39 is connected on the second side 63 of the release tape 11 to a surface of the release layer 57 of the release tape 11. The surface of the release layer 57 of the release tape 11 itself is not of pressure-sensitive adhesive design. However, in comparison with the surface of the backing layer 59 of the release tape 11, the surface of the backing layer 57 of the release tape 11 is designed in such a way that the material bond between the fixing adhesive tape 5 and the release tape 11 is mechanically more robust than the material bond between the release tape 5 and the first connecting adhesive tape 7.

In the first embodiment of the material tape system 1 according to the invention, the pressure-sensitive adhesive properties of the different pressure-sensitive adhesive surfaces are matched to one another as follows. A first adhesive force acting from the fixing adhesive surface 31 to the backing tape 3 is less than a second adhesive force acting from the connecting section 29 of the fixing adhesive tape 5 to the release tape 11. In this case, the second adhesive force acts from the third section of the plurality of sections of the adhesive surface of the adhesive layer 35 of the fixing adhesive tape 5 to the release tape 11. Furthermore, the second adhesive force acting from the connecting section 29 of the fixing adhesive tape 5 to the release tape 11 is greater than a third adhesive force acting from the connecting adhesive surface 39 of the first connecting adhesive tape 7 to the release tape 11. Furthermore, the third adhesive force acting from the connecting adhesive surface 39 of the first connecting adhesive tape 7 to the release tape 11 is less than a fourth adhesive force acting from the connecting section 37 of the first connecting adhesive tape 7 to the first end section 13 of the backing tape 3.

The first, second, third and fourth adhesive forces are each to be understood to mean a force threshold which must be overcome in order to detach the corresponding elements from one another under a load in the plane of the image in FIG. 1 and perpendicular to the first connecting adhesive tape direction of extent 45. The first adhesive force is a force threshold which must be overcome in order to detach the backing tape 3 and the fixing adhesive tape 5 from one another, the second adhesive force is a force threshold which must be overcome in order to detach the fixing adhesive tape 5 and the release tape 11 from one another, the third adhesive force is a force threshold which must be overcome in order to detach the first connecting adhesive tape 7 and the release tape 11 from one another, and the fourth adhesive force is a force threshold which must be overcome in order to detach the first connecting adhesive tape 7 and the backing tape 3 from one another.

When the material tape system 1 is then subjected to a tensile load in the plane of the image in FIG. 1 and perpendicular to the first connecting adhesive tape direction of extent 45, in that a tensile force acts on the fixing adhesive tape 5 and an oppositely acting tensile force acts on the first connecting adhesive tape 7, both the backing tape 3 and the fixing adhesive tape 5 are detached from one another and the connecting adhesive tape 7 and the release tape 11 are detached from one another, wherein both the fixing adhesive tape 5 and the release tape 11 and also the backing tape 3 and the first connecting adhesive tape 7 remain connected to one another.

Owing to the geometrical construction of the first embodiment of the material tape system 1 according to the invention, the ratios of the adhesive forces to one another ensure the desired result of the described detachment of the individual elements. The first embodiment of the material tape system 1 according to the invention is furthermore built up in such a way that the pressure-sensitive adhesive properties of the different pressure-sensitive adhesive surfaces are matched to one another as follows. A first strength threshold value of the connection between the fixing adhesive surface 31 and the backing tape 3 is lower than a second strength threshold value of the connection between the connecting section 29 of the fixing adhesive tape 5 and the release tape 11. In this case, the second strength threshold relates to the connection between the third section of the plurality of sections of the adhesive surface of the adhesive layer 35 of the fixing adhesive tape 5 and the release tape 11. Furthermore, the second strength threshold value of the connection between the connecting section 29 of the fixing adhesive tape 5 and the release tape 11 is higher than a third strength threshold value of the connection between the connecting adhesive surface 39 of the first connecting adhesive tape 7 and the release tape 11. Furthermore, the third strength threshold value of the connection between the connecting adhesive surface 39 of the first connecting adhesive tape 7 and the release tape 11 is lower than a fourth strength threshold value of the connection between the connecting section 37 of the first connecting adhesive tape 7 and the first end section 13 of the backing tape 3. The first, second, third and fourth strength threshold values are each to be understood to mean a strength threshold value which must be overcome in order to detach the corresponding elements from one another under a load in the plane of the image in FIG. 1 and perpendicular to the first connecting adhesive tape direction of extent 45. The first strength threshold value is a strength threshold value which must be overcome in order to detach the backing tape 3 and the fixing adhesive tape 5 from one another, the second strength threshold value is a strength threshold value which must be overcome in order to detach the fixing adhesive tape 5 and the release tape 11 from one another, the third strength threshold value is a strength threshold value which must be overcome in order to detach the first connecting adhesive tape 7 and the release tape 11 from one another, and the fourth strength threshold value is a strength threshold value which must be overcome in order to detach the first connecting adhesive tape 7 and the backing tape 3 from one another.

The features, technical effects and/or advantages described in connection with the first, second, third and fourth adhesive forces and in connection with the first, second, third and fourth strength threshold values also apply, at least in an analogous manner, to a first, second, third and fourth peeling force, which describes the force threshold which must be overcome in order to pull one element off another element. If, for example, in the first embodiment of the material tape system 1 according to the invention, the end of the fixing adhesive tape 5 which is on the outside left in FIG. 1 is initially pulled upwards perpendicularly to the first connecting adhesive tape direction of extent 45 and then upwards and counter to the first connecting adhesive tape direction of extent 45 in the plane of the image in FIG. 1, both the backing tape 3 and the fixing adhesive tape 5 as well as the connecting adhesive tape 7 and the release tape 11 are detached from one another owing to the ratios of the first, second, third and fourth peeling forces with respect to one another, wherein both the fixing adhesive tape 5 and the release tape 11 as well as the backing tape 3 and the first connecting adhesive tape 7 remain connected to one another.

As already described, the material tape system 1 can have a roll core with a circumferential outer surface. The fixing adhesive tape 5 can be connected to the outer surface by means of the connecting section 29, in particular by means of the second section of the plurality of sections of the adhesive surface of the adhesive layer 35 of the fixing adhesive tape 5. Alternatively, the second connecting adhesive tape 9 can be detachably connected to the circumferential outer surface of the roll core by means of the connecting adhesive surface 49.

FIG. 2 shows a schematic view of a second embodiment of the material tape system 1 according to the invention. The material tape system 1 has the backing tape 3, the fixing adhesive tape 5, the first connecting adhesive tape 7 and the second connecting adhesive tape 9. In comparison with the first embodiment of the material tape system 1 according to the invention in FIG. 1, the material tape system 1 according to the second embodiment does not have a release tape 11. In particular, the arrangement of the backing tape 3, the fixing adhesive tape 5 and the first connecting adhesive tape 7 which is provided in the second embodiment of the material tape system 1 according to the invention ensures that it is possible to dispense with a release tape 11 of the kind provided in the first embodiment of the material tape system 1 according to the invention. Thus, the second embodiment of the material tape system 1 according to the invention represents a particularly resource-saving alternative. As in the first embodiment of the material tape system 1 according to the invention, the release layer 25 of the backing tape 3 in the second embodiment of the material tape system 1 according to the invention is a release paper.

In the second embodiment of the material tape system 1 according to the invention too, the fixing adhesive tape 5 and the first connecting adhesive tape 7 are connected to the backing tape 3 in such a way that, when the fixing adhesive tape 5 is connected to the backing tape 3, the connecting adhesive surface 39 of the first connecting adhesive tape 7 is covered, and, when the fixing adhesive tape 5 is detached from the backing tape 3, the connecting adhesive surface 39 of the first connecting adhesive tape 7 is exposed. As shown in FIG. 2, when the fixing adhesive tape 5 is connected to the backing tape 3, the connecting adhesive surface 39 of the first connecting adhesive tape 7 is arranged on the first side 17 of the backing tape 3. The arrangement of the connecting adhesive surface 39 of the first connecting adhesive tape 7 on the first side 17 of the backing tape 3 can be achieved as shown in FIG. 2 by the first connecting adhesive tape 7 being wrapped around the first end section 13 of the backing tape. The first connecting adhesive tape 7 is arranged in a U shape and encloses the first end section 13 of the backing tape 3 in such a way that the first end face 21 is covered by the first connecting adhesive tape 7.

The fixing adhesive tape 5 has the pressure-sensitive adhesive layer 35, which has the adhesive surface with the plurality of sections. The first section of the plurality of sections of the adhesive surface of the adhesive layer 35 forms the pressure-sensitive fixing adhesive surface 5, by means of which the fixing adhesive tape 5 is detachably connected to the first end section 13 of the backing tape 3 on the first side 17 of the backing tape 3. In this case, the pressure-sensitive fixing adhesive surface 31 is connected to a section of the release layer 25 of the backing tape 3, wherein the surface of this section of the release layer 25 does not have pressure-sensitive adhesive properties, and therefore the pressure-sensitive fixing adhesive surface 31 can be detached particularly easily from this surface of the section of the release layer 25.

Between the first section and the second section (which is exposed in FIG. 2) of the plurality of sections of the adhesive surface of the adhesive layer 35 of the fixing adhesive tape 5, the third section of the plurality of sections of the adhesive surface of the adhesive layer 35 of the fixing adhesive tape 5 is provided. The third section forms a pressure-sensitive adhesive surface, by means of which the fixing adhesive tape 5 is connected to a surface of a section of the backing layer 41 of the first connecting adhesive tape 7 on the side of the backing layer 41 of the first connecting adhesive tape 7. The surface of the section of the backing layer 41 of the first connecting adhesive tape 7 is itself not of pressure-sensitive adhesive design. However, in comparison with the surface of the section of the release layer 25, the surface of the section of the backing layer 41 of the first connecting adhesive tape 7 is designed in such a way that the material bond between the fixing adhesive tape 5 and the first connecting adhesive tape 7 is mechanically more robust than the material bond between the fixing adhesive tape 5 and the backing tape 3.

The first connecting adhesive tape 7 has the pressure-sensitive adhesive layer 43, which has the adhesive surface with the plurality of sections. The first section of the plurality of sections of the adhesive surface of the adhesive layer 43 forms the pressure-sensitive connecting adhesive surface 39, which is covered by a surface of a section of the release layer 25 of the release tape 3 in FIG. 2. In this case, the pressure-sensitive connecting adhesive surface 39 on the first side 17 of the backing tape 3 is connected to the surface of the section of the release layer 25 of the backing tape 3 which is arranged on the first end section 13 of the backing tape 3. The surface of the section of the release layer 25 is not of pressure-sensitive adhesive design. In comparison with that surface of the section of the backing layer 7 of the first connecting adhesive tape 7 which faces the fixing tape 5, the surface of the section of the backing layer 25 on the first end section 13 is designed in such a way that the material bond between the fixing adhesive tape 5 and the first connecting adhesive tape 7 is mechanically more robust than the material bond between the first connecting adhesive tape 7 and the backing tape 3 on the first side 17 of the backing tape 3. The second section of the plurality of sections of the adhesive surface of the adhesive layer 43 of the first connecting adhesive tape 7 is arranged on the second side 19 of the backing tape 3 and forms a pressure-sensitive adhesive surface by means of which the first connecting adhesive tape 7 is connected to a surface of a section of the backing layer 27 of the backing tape 3 at the first end section 13 of the backing tape 3.

In comparison with the surface of the section of the release layer 25 of the backing tape 3 on the first end section 13 of the backing tape 3 on the first side 17 of the backing tape 3, the surface of the section of the backing layer 27 of the backing tape 3 on the first end section 13 of the backing tape 3 on the second side 19 of the backing tape 3 is designed in such a way that the material bond between the backing tape 3 and the first connecting adhesive tape 7 on the second side 19 of the backing tape 3 is mechanically more robust than the material bond between the backing tape 3 and the first connecting adhesive tape 7 on the first side 17 of the backing tape 3.

In the second embodiment of the material tape system 1 according to the invention, the pressure-sensitive adhesive properties of the different pressure-sensitive adhesive surfaces are matched to one another as follows. A first adhesive force acting from the fixing adhesive surface 31 to the backing tape 3 is less than a second adhesive force acting from the connecting section 29 of the fixing adhesive tape 5 to the first connecting adhesive tape 7. In this case, the second adhesive force acts from the third section of the plurality of sections of the adhesive surface of the adhesive layer 35 of the fixing adhesive tape 5 to the first connecting adhesive tape 7. Furthermore, the second adhesive force acting from the connecting section 29 of the fixing adhesive tape 5 to the first connecting adhesive tape 7 is greater than a third adhesive force acting from the connecting adhesive surface 39 of the first connecting adhesive tape 7 to the first end section 13 of the backing tape 13. Furthermore, the third adhesive force acting from the connecting adhesive surface 39 of the first connecting adhesive tape 7 to the first end section 13 of the backing tape 13 is less than a fourth adhesive force acting from the connecting section 37 of the first connecting adhesive tape 7 to the first end section 13 of the backing tape 3.

The first, second, third and fourth adhesive forces are each to be understood to mean a force threshold which must be overcome in order to detach the corresponding elements from one another under a load in the plane of the image in FIG. 2 and perpendicular to the first connecting adhesive tape direction of extent 45. The first adhesive force is a force threshold which must be overcome in order to detach the backing tape 3 and the fixing adhesive tape 5 from one another, the second adhesive force is a force threshold which must be overcome in order to detach the fixing adhesive tape 5 and the first connecting adhesive tape 7 from one another, the third adhesive force is a force threshold which must be overcome in order to detach the first connecting adhesive tape 7 and the backing tape 3 from one another on the first side 17 of the backing tape 3, and the fourth adhesive force is a force threshold which must be overcome in order to detach the first connecting adhesive tape 7 and the backing tape 3 from one another on the second side 19 of the backing tape 3.

When the material tape system 1 is then subjected to a tensile load in the plane of the image in FIG. 1 and perpendicular to the first connecting adhesive tape direction of extent 45, in that a tensile force acts on the fixing adhesive tape 5 and an oppositely acting tensile force acts on the first connecting adhesive tape 7 on the second side 19 of the backing tape 3, both the backing tape 3 and the fixing adhesive tape 5 are detached from one another and the first connecting adhesive tape 7 and the backing tape 3 are detached from one another on the first side 17 of the backing tape 3, wherein first of all both the fixing adhesive tape 5 and the first connecting adhesive tape 7 and also the backing tape 3 and the first connecting adhesive tape 7 remain connected to one another on the second side 19 of the backing tape 3. Subsequently, the fixing adhesive tape 5 can be detached from the first connecting adhesive tape 7 and the section of the first connecting adhesive tape 7 which is arranged on the first side 17 of the backing tape 3 in FIG. 2 can be folded over in the direction of the first connecting adhesive tape direction of extent 45, with the result that the first connecting adhesive tape 7 extends along the first connecting adhesive tape direction of extent 45. By removing the fixing adhesive tape 5 and folding over the first connecting adhesive tape 7, the connecting adhesive surface 39 of the first connecting adhesive tape 7 can be exposed.

Owing to the geometrical construction of the second embodiment of the material tape system 1 according to the invention, the ratios of the adhesive forces to one another ensure the desired result of the described detachment of the individual elements. The second embodiment of the material tape system 1 according to the invention is furthermore built up in such a way that the pressure-sensitive adhesive properties of the different pressure-sensitive adhesive surfaces are matched to one another as follows. A first strength threshold value of the connection between the fixing adhesive surface 31 and the backing tape 3 is lower than a second strength threshold value of the connection between the connecting section 29 of the fixing adhesive tape 5 and the first connecting adhesive tape 7. In this case, the second strength threshold relates to the connection between the third section of the plurality of sections of the adhesive surface of the adhesive layer 35 of the fixing adhesive tape 5 and the first connecting adhesive tape 7. Furthermore, the second strength threshold value of the connection between the connecting section 29 of the fixing adhesive tape 5 and the first connecting adhesive tape 11 is higher than a third strength threshold value of the connection between the connecting adhesive surface 39 of the first connecting adhesive tape 7 and the first end section 13 of the backing tape 13. Furthermore, the third strength threshold value of the connection between the connecting adhesive surface 39 of the first connecting adhesive tape 7 and the first end section 13 of the backing tape 11 is lower than a fourth strength threshold value of the connection between the connecting section 37 of the first connecting adhesive tape 7 and the first end section 13 of the backing tape 3. The first, second, third and fourth strength threshold values are each to be understood to mean a strength threshold value which must be overcome in order to detach the corresponding elements from one another under a load in the plane of the image in FIG. 2 and perpendicular to the first connecting adhesive tape direction of extent 45. The first strength threshold value is a strength threshold value which must be overcome in order to detach the backing tape 3 and the fixing adhesive tape 5 from one another, the second strength threshold value is a strength threshold value which must be overcome in order to detach the fixing adhesive tape 5 and the first connecting adhesive tape 7 from one another, the third strength threshold value is a strength threshold value which must be overcome in order to detach the first connecting adhesive tape 7 and the backing tape 3 from one another on the first side 17 of the backing tape 3, and the fourth strength threshold value is a strength threshold value which must be overcome in order to detach the first connecting adhesive tape 7 and the backing tape 3 from one another on the second side 19 of the backing tape 3.

The features, technical effects and/or advantages described in connection with the first, second, third and fourth adhesive forces and in connection with the first, second, third and fourth strength threshold values also apply, at least in an analogous manner, to a first, second, third and fourth peeling force, which describes the force threshold which must be overcome in order to pull one element off another element. If, for example, in the second embodiment of the material tape system 1 according to the invention, the end of the fixing adhesive tape 5 which is on the outside right in FIG. 2 is initially pulled upwards perpendicularly to the first connecting adhesive tape direction of extent 45 and then upwards and counter to the first connecting adhesive tape direction of extent 45 in the plane of the image in FIG. 2, the fixing adhesive tape 5 and the first connecting adhesive tape 7 are first detached from one another and, together with this, in particular simultaneously therewith, the first connecting adhesive tape 7 and the backing tape 3 are detached from one another on the first side 17 of the backing tape 3 and then the fixing adhesive tape 5 and the backing tape 3 are detached from one another owing to the ratios of the first, second, third and fourth peeling forces with respect to one another, wherein the first connecting adhesive tape 7 and the backing tape 3 remain connected to one another on the second side 19 of the backing tape 3.

The features, technical effects and/or advantages described in connection with the first embodiment of the material tape system 1 according to the invention also apply at least in an analogous manner to the second embodiment of the material tape system according to the invention.

FIG. 3 shows a schematic view of one embodiment of a material tape system assembly 65 according to the invention. FIG. 4 shows two schematic views of the embodiment of the material tape system assembly 65 according to the invention in FIG. 3 in a top view (FIG. 4a) and in a view from below (FIG. 4b). The material tape system assembly 65 has a first material tape system 1 according to a third embodiment of the material tape system 1 according to the invention and a second material tape system 1 according to the third embodiment of the material tape system 1 according to the invention. The connecting adhesive surface 39 of the first connecting adhesive tape 7 of the first material tape system 1 is connected to the second end section 15 of the backing tape 3 of the second material tape system 1 on a second side 19 of the backing tape 3 of the second material tape system 1. The connecting adhesive surface 49 of the second connecting adhesive tape 9 of the second material tape system 1 is connected to the first end section 13 of the backing tape 3 of the first material tape system 1 on the first side 17 of the backing tape 3 of the first material tape system 1.

As already described, the material tape system assembly 65 shown in FIG. 3 has the first material tape system 1 and the second material tape system 1 in each case according to the third embodiment of the material tape system 1 according to the invention. When the third embodiment of the material tape system 1 according to the invention is used, the first end section 13 of the backing tape 3 of the first material tape system 1 is arranged between the second end section 15 of the backing tape 3 of the second material tape system 1 and the connecting adhesive surface 49 of the second connecting adhesive tape 9, and the second end section 15 of the backing tape 3 of the second material tape system 1 is arranged between the first end section 13 of the backing tape 3 of the first material tape system 1 and the connecting adhesive surface 39 of the first connecting adhesive tape 7. By this means, a particularly space-saving material tape system assembly 65 is provided. When the first or second embodiment of the material tape system 1 according to the invention is used, the first end face 21 of the first end section 13 of the backing tape 3 of the first material tape system 1 and the second end face 23 of the second end section 15 of the backing tape 3 of the second material tape system 1 can rest against one another. As a result, the backing tape 3 of the first material tape system 1 and the backing tape 3 of the second material tape system 1 are aligned, which is advantageous, in particular, when the material tape system assembly 65 is used in an automated robot applicator since the guidance of the material tape system assembly 65 by the robot applicator is simplified and, in particular, the likelihood of the material tape system assembly 65 being caught in the robot applicator is significantly reduced.

The first end section 13 of the backing tape 11 has a first edge region 67 and a second edge region 69. The second end section 15 of the backing tape 11 has a first edge region 71 and a second edge region 73. The backing tape 3 of the first material tape system 1 and the backing tape 3 of the second material tape system 1 are arranged in such a way that a first tangential surface running perpendicularly to the connecting adhesive surface 39 of the first connecting adhesive tape 7 of the first material tape system 1 runs along the first edge region 67 of the first end section 13 of the backing tape 3 of the first material tape system 1 and along a first edge region 71 of the second end section 15 of the backing tape 3 of the second material tape system 1, and a second tangential surface running parallel to the first tangential surface runs along the second edge region 69 of the first end section 13 of the backing tape 3 of the first material tape system 1 and along the second edge region 73 of the second end section 15 of the backing tape 3 of the second material tape system 1. By virtue of this arrangement, the backing tape 3 of the first material tape system 1 and the backing tape 3 of the second material tape system 1 are aligned, which is advantageous particularly when the material tape system assembly 65 is used in an automated robot applicator.

In the embodiment of the material tape system assembly 65 according to the invention which is illustrated in FIGS. 3 and 4, a multiplicity of punched parts 75 is arranged on the first side 17 of each backing tape 3. In other embodiments (not shown) of the material tape system assembly 65 according to the invention, it is possible for a multiplicity of punched parts 75 to be arranged exclusively on the second side 19 of the backing tape 3. In other embodiments (not shown) of the material tape system assembly 65 according to the invention, it is possible both for a multiplicity of punched parts 75 to be arranged on the first side 17 of the backing tape 3 and for a multiplicity of punched parts 75 to be arranged on the second side 19 of the backing tape 3. Thus, different arrangements of punched parts 75 can be provided on the backing tape 3. By means of different arrangements of punched parts 75 on the backing tape 3, it is possible to arrange the punched parts 75 of the corresponding application in an optimum manner. It is thereby possible to provide material tape systems 1 and material tape system assemblies 65 that can be used in a flexible manner.

As already described, the detachable connection between the fixing adhesive tape 5 and the backing tape 3 ensures that the function of connecting the backing tape 3, for example to the roll core of the material tape system 1 or to the section of the backing tape 3, in particular on the first side 17 of the backing tape 3, can be fulfilled by the fixing adhesive tape 5 and that the structural make up of the backing tape 3 can be chosen independently of this function. This has been found to be advantageous particularly in the case in which a multiplicity of punched parts 75 is arranged on the first side 17 of the backing tape 3 and/or a multiplicity of punched parts 75 is arranged on the second side 19 of the backing tape 3 since in this case the backing tape 3 can be constructed in a manner that is structurally adapted to the multiplicity of punched parts 75.

In particular, the release layer 25 has been found to be advantageous since it can have a section to which, in particular, the pressure-sensitive adhesive surfaces, such as, for example, the adhesive surface of the fixing adhesive tape 5, by means of which the fixing adhesive tape 5 can be detachably connected to the section of the backing tape 3 on the first side 17 of the backing tape 3, or the connecting adhesive surface 49, can be connected and from which these pressure-sensitive adhesive surfaces can be detached particularly easily, in particular when the material tape system 1 is to be used, for example, in an automated robot applicator for applying a multiplicity of punched parts 75.

The material tape system assembly 65 is produced as follows. The first material tape system 1 and the second material tape system 1 are provided. The fixing adhesive tape 5 is then detached from the backing tape 3 of the first material tape system 1. After this, the connecting adhesive surface 39 of the first connecting adhesive tape 7 of the first material tape system 1 is connected to the second end section 15 of the backing tape 3 of the second material tape system 1 on the second side 19 of the backing tape 3 of the second material tape system 1. The connecting adhesive surface 49 of the second connecting adhesive tape 9 of the second material tape system 1 is then connected to the first end section 13 of the backing tape 3 of the first material tape system 1 on the first side 17 of the backing tape 3 of the first material tape system 1.

The features, technical effects and/or advantages described in connection with the first embodiment of the material tape system 1 according to the invention and the features, technical effects and/or advantages described in connection with the second embodiment of the material tape system 1 according to the invention also apply at least in an analogous manner to the third embodiment of the material tape system 1 according to the invention and to the embodiment of the material tape system assembly 65 according to the invention.

In addition, it should be noted that “having” does not exclude other elements or steps and “one” or “a” does not exclude a multiplicity. Attention is furthermore drawn to the fact that features which have been described with reference to one of the above exemplary embodiments can also be used in combination with other features of other exemplary embodiments described above. Reference signs in the claims should not be regarded as a restriction.

### REFERENCE SIGNS

1 material tape system
3 backing tape
5 adhesive fixing tape
7 first connecting adhesive tape
9 second connecting adhesive tape
11 release tape
13 first end section of the backing tape
15 second end section of the backing tape
17 first side of the backing tape
19 second side of the backing tape
21 first end face of the first end section
23 second end face of the second end section
25 release layer of the backing tape
27 backing layer of the backing tape
29 connecting section of the fixing adhesive tape
31 fixing adhesive surface of the fixing adhesive tape
33 backing layer of the fixing adhesive tape
35 adhesive layer of the fixing adhesive tape
37 connecting section of the first connecting adhesive tape
39 connecting adhesive surface of the first connecting adhesive tape
41 backing layer of the first connecting adhesive tape
43 adhesive layer of the first connecting adhesive tape
45 first connecting adhesive tape direction of extent
47 connecting section of the second connecting adhesive tape
49 connecting adhesive surface of the second connecting adhesive tape
51 backing layer of the second connecting adhesive tape
53 adhesive layer of the second connecting adhesive tape
55 second connecting adhesive tape direction of extent
57 release layer of the release tape
59 backing layer of the release tape
61 first side of the release tape
63 second side of the release tape
65 material tape system assembly
67 first edge region of the first end section
69 second edge region of the first end section
71 first edge region of the second end section
73 second edge region of the second end section
75 punched part

1. Material tape system (1) having
a backing tape (3), which has a first end section (13) and a second end section (15) and extends from the first end section (13) to the second end section (15),
a fixing adhesive tape (5) having a fixing adhesive surface (31), by means of which the fixing adhesive tape (5) is detachably connected to the first end section (13) of the backing tape (3) on a first side (17) of the backing tape (3),
a first connecting adhesive tape (7) having a connecting section (37), by means of which the first connecting adhesive tape (7) is connected to the first end section (13) of the backing tape (3) on a second side (19) of the backing tape (3), which is opposite to the first side (17) of the backing tape (3),
wherein the fixing adhesive tape (5) and the first connecting adhesive tape (7) are connected to the backing tape (3) in such a way that,
when the fixing adhesive tape (5) is connected to the backing tape (3), a connecting adhesive surface (39) of the first connecting adhesive tape (7) is covered, and,
when the fixing adhesive tape (5) is detached from the backing tape (3), the connecting adhesive surface (39) of the first connecting adhesive tape (7) is exposed.

2. Material tape system (1) according to claim 1, wherein the material tape system (1) has a release tape (11) having a first side (61) and a second side (63), wherein, when the fixing adhesive tape (5) is connected to the backing tape (3), the release tape (11) is arranged between the fixing adhesive tape (5) and the first connecting adhesive tape (7) in such a way that the fixing adhesive surface (31) faces the first side (61) of the release tape (11) and the connecting adhesive surface (39) faces the second side (63) of the release tape (11).

3. Material tape system (1) according to claim 2, wherein the release tape (11) is connected on its first side (61) to the fixing adhesive tape (5) and is detachably connected on its second side (63) to the connecting adhesive surface (39) of the first connecting adhesive tape (7) in such a way that, when the fixing adhesive tape (5) is detached from the backing tape (3), the release tape (11) is detached from the connecting adhesive surface (39).

4. Material tape system (1) according to claim 1, wherein the connecting adhesive surface (39) of the first connecting adhesive tape (7) is covered by the release tape (11).

5. Material tape system (1) according to claim 2, wherein a first adhesive force acting from the fixing adhesive surface (31) to the backing tape (3) is less than a second adhesive force acting from a connecting section (29) of the fixing adhesive tape (5) to the release tape (11).

6. Material tape system (1) according to claim 2, wherein the second adhesive force acting from the connecting section (29) of the fixing adhesive tape (5) to the release tape (11) is greater than a third adhesive force acting from the connecting adhesive surface (39) of the first connecting adhesive tape (7) to the release tape (11).

7. Material tape system (1) according to claim 2, wherein the third adhesive force acting from the connecting adhesive surface (39) of the first connecting adhesive tape (7) to the release tape (11) is less than a fourth adhesive force acting from the connecting section (37) of the first connecting adhesive tape (7) to the first end section (13) of the backing tape (3).

8. Material tape system (1) according to claim 1, wherein, when the fixing adhesive tape (5) is connected to the backing tape (3), the connecting adhesive surface (39) of the first connecting adhesive tape (7) is arranged on the first side (17) of the backing tape (3).

9. Material tape system (1) according to claim 1, wherein the first connecting adhesive tape (7) extends in a first connecting adhesive tape direction of extent (45) away from the first end section (13) of the backing tape (3), wherein an extent of the connecting section (37) of the first connecting adhesive tape (7) in the first connecting adhesive tape direction of extent (45) corresponds to between 20% and 40% of an extent of the first connecting adhesive tape (7) in the first connecting adhesive tape direction of extent (45).

10. Material tape system (1) according to claim 1, wherein the material tape system (1) has a roll core with a circumferential outer surface, wherein the fixing adhesive tape (5) has a connecting section (29), by means of which the fixing adhesive tape (5) is connected to the outer surface.

11. Material tape system (1) according to claim 1, wherein the material tape system (1) has a second connecting adhesive tape (9) having a connecting section (47), by means of which the second connecting adhesive tape (9) is connected to the second end section (15) of the backing tape (3) on the first side (17) of the backing tape (3), and having a connecting adhesive surface (49).

12. Material tape system (1) according to claim 11, wherein the material tape system (1) has a roll core with a circumferential outer surface, wherein the second connecting adhesive tape (9) is connected to the outer surface by means of the connecting adhesive surface (49).

13. Material tape system (1) according to claim 1, wherein a multiplicity of punched parts (75) is arranged on the first side (17) of the backing tape (3) and/or a multiplicity of punched parts (75) is arranged on the second side (19) of the backing tape (3).

14. Material tape system assembly (65) comprising a first material tape system (1) according to claim 1 and a second material tape system (1) according to claim 1, wherein the connecting adhesive surface (39) of the first connecting adhesive tape (7) of the first material tape system (1) is connected to the second end section (15) of the backing tape (3) of the second material tape system (1) on a second side (19) of the backing tape (3) of the second material tape system (1).

15. Material tape system assembly (65) according to claim 14, wherein the connecting adhesive surface (49) of the second connecting adhesive tape (9) of the second material tape system (1) is connected to the first end section (13) of the backing tape (3) of the first material tape system (1) on the first side (17) of the backing tape (3) of the first material tape system (1).

16. Material tape system assembly (65) according to claim 14, wherein the backing tape (3) of the first material tape system (1) and the backing tape (3) of the second material tape system (1) are arranged in such a way that
a first tangential surface running perpendicularly to the connecting adhesive surface (39) of the first connecting adhesive tape (7) of the first material tape system (1) runs along a first edge region (67) of the first end section (13) of the backing tape (3) of the first material tape system (1) and along a first edge region (71) of the second end section (15) of the backing tape (3) of the second material tape system (1), and
a second tangential surface running parallel to the first tangential surface runs along a second edge region (69) of the first end section (13) of the backing tape (3) of the first material tape system (1) and along a second edge region (73) of the second end section (15) of the backing tape (3) of the second material tape system (1).

17. Material tape system assembly (65) according to claim 14, wherein a first end face (21) of the first end section (13) of the backing tape (3) of the first material tape system (1) and a second end face (23) of the second end section (15) of the backing tape (3) of the second material tape system (1) rest against one another.

18. Method for producing a material tape system assembly (65) according to claim 1, wherein the method comprises the following steps:
providing the first material tape system (1);
providing the second material tape system (1);
detaching the fixing adhesive tape (5) from the backing tape (3) of the first material tape system (1); and
connecting the connecting adhesive surface (39) of the first connecting adhesive tape (7) of the first material tape system (1) to the second end section (15) of the backing tape (3) of the second material tape system (1) on the second side (19) of the backing tape (3) of the second material tape system (1).

19. Method according to claim 18, wherein the method has the following additional step:
connecting the connecting adhesive surface (49) of the second connecting adhesive tape (9) of the second material tape system (1) to the first end section (13) of the backing tape (3) of the first material tape system (1) on the first side (17) of the backing tape (3) of the first material tape system (1).

20. Method of using a material tape system (1) according to claim 1 in an automated robot applicator.
